(19) United States
(12) Patent Application Publication
(10) Pub. No.: US 2011/0248530 A1
(43) Pub. Date: Oct. 13, 2011

(54) Seating Furniture with a Seat Which can be Pivoted into a Standing Up Assistance Position

(75) Inventor: Erich Sartisohn, Bielefeld (DE)

(73) Assignee: FERDINAND LUSCH GMBH & CO. KG, Bielefeld (DE)

(21) Appl. No.: 13/081,077

(22) Filed: Apr. 6, 2011

(30) Foreign Application Priority Data
Apr. 7, 2010 (DE) 102010014126.7-14

(51) Int. Cl. A61G 5/14; A47C 1/034

(52) U.S. Cl. 297/83

(57) ABSTRACT

Seating furniture, in particular an armchair or sofa, includes a base frame, a backrest, a seat and a foot part. The backrest and the foot part are coupled below the seat by a coupling linkage. The seat is held on the base frame so as to be pivotable from a sitting position into a standing up assistance position. The coupling linkage transmits a pivoting movement of the backrest relative to the seat onto the foot part and vice versa. A stop abuts on the foot part, the coupling linkage and/or the backrest in a rear position of the foot part. The stop, together with the coupling linkage, converts a pivoting of the seat relative to the base frame from the sitting position into a standing up assistance position into a pivoting of the backrest relative to the seat while increasing the opening angle between the backrest and seat.

The invention relates to seating furniture, in particular an armchair or sofa, with a base frame, a backrest, a seat and a foot part, the backrest and the foot part being coupled below the seat by a coupling linkage, the seat being held on the base frame so as to be pivotable from a sitting position into a standing up assistance position and the seat face of the seat being inclined forward in the standing up assistance position.

Corresponding seating furniture items are known from the prior art. These are, in particular, armchairs, which can adopt both a reclining position and also a standing up assistance position. In the reclining position, the foot part of the seating furniture is arranged in a front use position, in which the user can place his feet or legs on the foot part. In the standing up assistance position, the seat adopts an upper position, in which the seat face is inclined forward. This standing up assistance position makes it easier, in particular for older users of the seating furniture, to stand up again from it.

An armchair of the type mentioned at the outset is known, for example, from DE 20 2004 018 898 U1. The armchair has a base frame, in which a foot part, a seat and a backrest are held. Furthermore, a mounting is provided which is configured to adjust the foot part, the seat and the backrest depending on the sitting position. The mounting has three actuating drives to adjust the armchair.

In a sitting position of the armchair, the foot part is arranged below the seat and the backrest oriented predominantly vertically. From this sitting position, the armchair can be adjusted into a first reclining position, in which the foot part is extended into a front use position. The seat is then in a position inclined to the rear. The backrest encloses, with the seat, the same opening angle as in the sitting position. So that the user can adopt a still lower reclining position, from this position of the armchair, the backrest can be pivoted to the rear relative to the seat. In this case, the opening angle between the backrest and the seat increases.

Proceeding from the sitting position, the armchair can also be adjusted into a standing up assistance position. For this purpose, the seat is inclined forward relative to the sitting position and raised relative to the base frame of the armchair. The foot part, in this case, remains arranged below the seat, so that it does not hinder the user when standing up.

The complexity of the mounting and the low degree of comfort for the user in the standing up assistance position are disadvantageous in the known seating furniture. In the standing up assistance position, the user often adopts a posture which is felt to be unnatural.

The invention is therefore based on the object of designing and developing the seating furniture mentioned at the outset and described in more detail above in such a way that a greater degree of comfort is achieved for the user in the standing up assistance position, without thereby disproportionately increasing the complexity of the mounting.

This object is achieved in the seating furniture according to the preamble of claim 1 in that the coupling linkage is configured to transmit a pivoting movement of the backrest relative to the seat to the foot part and vice versa, in that a stop is provided to abut on the foot part, the coupling linkage and/or the backrest in a rear position of the foot part and in that the stop is configured, together with the coupling linkage, to convert a pivoting of the seat relative to the base frame from the sitting position into a standing up assistance position into a pivoting of the backrest relative to the seat while increasing the opening angle between the backrest and seat.

In the seating furniture according to the invention, the backrest and the foot part are connected by a coupling linkage, so a pivoting of the backrest relative to the seat also leads to a pivoting of the foot part relative to the seat. The coupling linkage in this case works in two directions. This means that a pivoting of the foot part relative to the seat, in the same manner leads to a pivoting of the backrest relative to the seat. When the seating furniture is adjusted, a pivoting movement of the backrest about the seat is thus directly connected, at least in regions, with a pivoting movement of the foot part relative to the seat.

When adjusting the seating furniture, either the foot part, the coupling linkage and/or the backrest can come to abut on a stop. This is the case in one position of the seating furniture, in which the foot part adopts a rear position. In this rear position, the foot part is preferably retracted, i.e. arranged below the seat. It is particularly expedient in this context, if this rear position coincides with the rest position which the foot part adopts when the seating furniture is in the sitting position.

In what position of the seating furniture the stop is located precisely and against which component of the seating furniture the stop comes to abut, is less decisive. However, it is important that a movement of the foot part and backrest coupled by means of the coupling linkage is, in each case, limited by the stop in relation to the seat. Moreover, the stop should cooperate with the coupling linkage, the foot part and/or the backrest in such a way that a pivoting of the backrest in relation to the seat accompanies the adjustment of the seating furniture from the sitting position into the standing up assistance position.

This preferably means that apart from the backrest, the foot part is also pivoted relative to the seat between the sitting position and the standing up assistance position. This is then produced because of the coupling of the backrest and the foot part by means of the coupling linkage, which is consequently also adjusted relative to the seat during the adjustment of the seating furniture from the sitting position into the standing up assistance position.

It is particularly simple if the stop comes to abut on the foot part when the seating furniture is adjusted. As a result, the rest position of the foot part, which the foot part preferably adopts in the sitting position of the seating furniture, can be defined. Then, because of the coupling of the foot part and backrest, the position of the backrest, in particular the opening angle between the seat and backrest in the sitting position, can also be determined. When the seating furniture is adjusted from the sitting position into the standing up assistance position, a free pivotability of the foot part can be dispensed with. This need not also apply in the same way to the backrest, as the backrest is preferably moved relative to the base frame, specifically in particular upward and forward, during the adjustment of the seating furniture from the sitting position into the standing up assistance position.

During the adjustment of the seating furniture from the sitting position into the standing up assistance position, however, the backrest and the seat do not move in the same manner, but relative to one another. In this case, the backrest is inclined to the rear relative to the seat, so the opening angle between the backrest and the seat increases. This gives the user of the seating furniture the possibility of keeping his upper body substantially upright even in the standing up assistance position, which increases the comfort for the user.

The base frame is basically taken to mean the components of the seating furniture, which are not influenced by the adjustment of the seating furniture, but retain their position. These may be side parts, frame parts and further components connected to these parts, which are only subject to a spatial movement when the seating furniture as such is moved.

Seating furniture in the sense of the invention is taken to mean, in particular, armchairs. The seating furniture, may, however, also be a sofa or a couch. In a first preferred embodiment of the seating furniture, the mounting can be configured to limit the degree of pivoting of the foot part from a front use position in the direction below the seat. This means that the foot part can be pivoted from the front use position to such an extent in the direction of the rear rest position of the foot part and optionally beyond it until the stop comes to abut on the foot part, the backrest and/or the coupling linkage. A structurally simple solution provides that the further pivoting of the foot part takes place by the abutting of the stop on the foot part, the backrest and/or the coupling linkage in the rear rest position of the foot part. In other words, the stop is effective when the seating furniture is in the sitting position and/or the foot part is in the rest position.

Alternatively, or additionally, it may be provided that the stop is designed to keep the foot part in a substantially stationary position in relation to the base frame when the seat is pivoted from the sitting position into the standing assistance position. Therefore, the foot part, when the seat is pivoted from the sitting position into the standing up assistance position, is not pivoted or, in any case insignificantly pivoted, relative to the base frame. Nevertheless, the foot part is pivoted relative to the seat, which, in relation to the seat, equates to a pivoting of the foot part in the direction of the front use position thereof. As the foot part is coupled by the coupling linkage to the backrest, the backrest is simultaneously pivoted to the rear relative to the seat. This pivoting movement of the backrest in turn equates, in relation to the seat, to the pivoting of the backrest from the sitting position in the direction of the reclining position.

A structurally simple configuration of the seating furniture is achieved if the backrest and the foot part are rigidly coupled by means of the coupling linkage. There is thus a direct connection between the backrest and the foot part, so that when the seating furniture is adjusted, a pivoting of the backrest in relation to the seat, is directly transmitted, in any case in regions, to the foot part, and vice versa.

It is particularly expedient in this context, if the backrest and the foot part are coupled by the coupling linkage for the constantly synchronous pivoting of the backrest and the foot part relative to the seat. This means that a pivoting of the foot part relative to the seat accompanies a synchronous pivoting of the backrest and vice versa over the entire adjustment range of the seating furniture, i.e. over the entire pivoting range of the foot part and backrest. Despite this synchronous pivoting of the foot part and backrest in relation to the seat, the foot part and the backrest can in each case be pivoted through different angles relative to the seat. In other words, no symmetrical pivoting of the foot part and backrest relative to the seat are necessary. The pivoting range of the foot part relative to the seat is preferably namely significantly greater than the pivoting range of the backrest relative to the seat.

In a further preferred configuration of the seating furniture, a further stop is provided, which limits the pivoting of the seat from the standing up assistance position into the sitting position. For this purpose, the further stop may come to abut on the seat, for the sake of simplicity, specifically preferably in the sitting position of the seating furniture. This allows a structurally simple configuration of the seating furniture. The stop may further be configured in such a stable manner that the seat in the sitting position is to a considerable extent carried by the stop, so part of the body weight of the user can be deflected via the seat stop to the ground.

In order to give the user of the seating furniture the possibility of standing up as comfortably as possible from the seating furniture, an actuating drive may be provided to pivot the seat from the seating position into the standing up assistance position. The actuating drive can then, in a structurally simple configuration, be connected by one end to the base frame and by another end to the seat, the foot part and/or the backrest.

Basically, it is also conceivable, however, to adjust the seat from the sitting position into the standing up assistance position without motor assistance. Overall, it is advisable for the further stop in the rear region of the seat to come to abut thereon. The seat can then be pivotably mounted to the base frame in the front region.

As an alternative or in addition, an actuating drive may be provided to adjust the seating furniture from a reclining position with the foot part in a front use position into a sitting position with the foot part in a rear rest position. This increases the comfort for the user as he can adjust the seating furniture from a sitting position into the reclining position and back without an exertion of force.

To save actuating drives, merely one single actuating drive may be provided to adjust the seating furniture. The seating furniture can then be adjusted from a reclining position with the foot part in a front use position via a sitting position, preferably with the foot part in a rear rest position, through to the standing up assistance position with a seat face of the seat inclined forward. The corresponding seating furniture consequently allows all the positions of the seating furniture to be adjusted with a single actuating drive.

A particularly simple and expedient configuration of the seating furniture is achieved in this case if the actuating member of the actuating drive with the foot part in the use position is in a retracted position, the actuating member with the seat in the standing up assistance position is in an extended position and the actuating member in the sitting position is in a position between the retracted and the extended position. Only a linear adjustment of the actuating drive configured for the sake of simplicity as a linear drive, is therefore necessary in order to be able to adopt all the positions of the seating furniture.

Moreover, a comparatively uniform adjustment of the seating furniture from the reclining position via the sitting position into the standing up assistance position is made possible. In this case, firstly the foot part is retracted to under the seat to such an extent that the stop is active and prevents a further adjustment of the foot part. This leads to the fact that a further extension of the actuating member of the actuating drive leads to a raising and therefore pivoting of the seat relative to the base frame. At the same time, the relative pivoting of the foot part, which is fixed relative to the base frame because of the stop, relative to the seat, is converted into a relative pivoting of the backrest relative to the seat. As a result, the opening angle between the seat and backrest is increased. The seating furniture is then adjusted from the standing up assistance position into the sitting position by retracting the actuating member of the actuating drive, the seat then being pivoted to the rear until it preferably comes to abut on the further stop. A further pivoting of the seat can thereby be prevented. A further drawing in of the actuating member of the adjusting drive finally leads to a pivoting of the foot part in the direction of the front use position.

In order to achieve a structure of the seating furniture that is as simple as possible and to save unnecessary components, it is preferred for the backrest to be pivotably fastened to the seat.

The seat can be pivotably configured in a structurally simple manner in that it is pivotably fastened to the base frame in the front region. However, any other pivotable mounting relative to the base frame is also possible, for example by a supplementary mounting.

The invention will be described in more detail below with the aid of drawings merely showing one exemplary embodiment.

In the drawings:

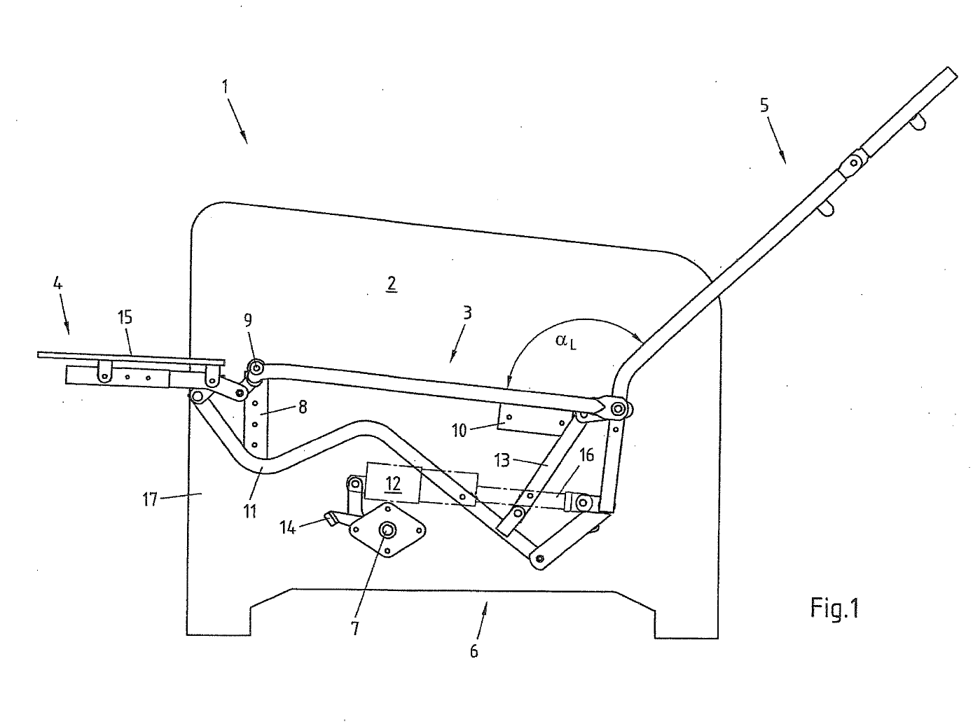

FIG. 1 shows an item of seating furniture according to the invention in a reclining position,

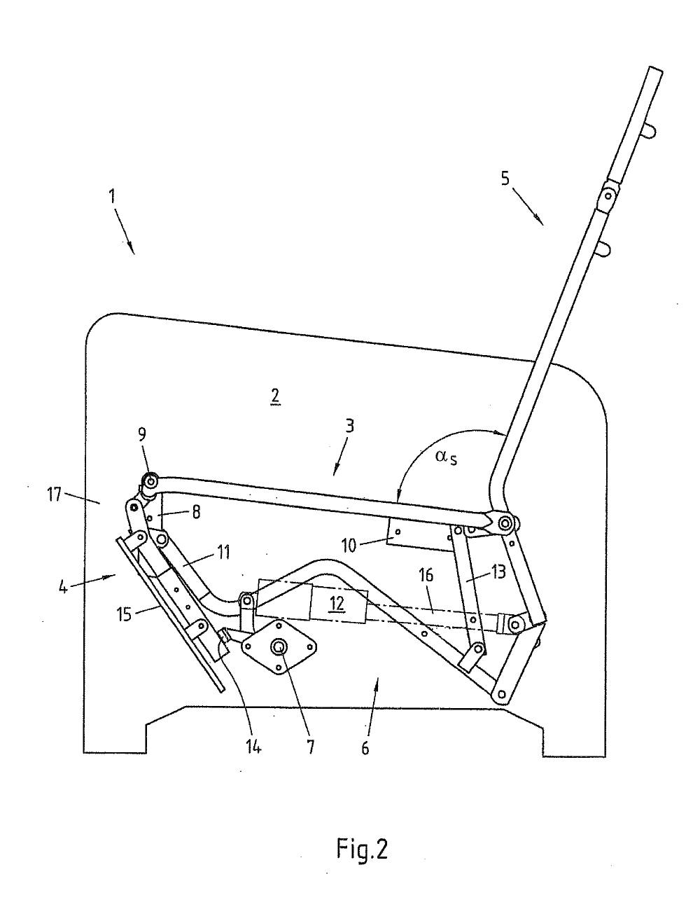

FIG. 2 shows the item of seating furniture from FIG. 1 in a sitting position and

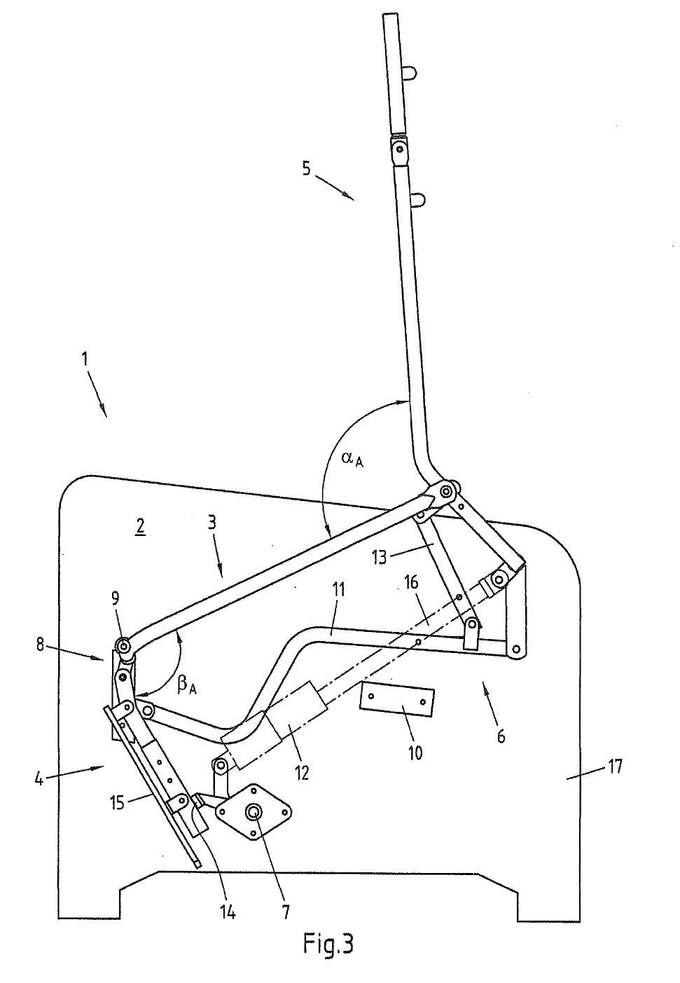

FIG. 3 shows the item of seating furniture from FIG. 1 in a standing up assistance position.

FIG. 1 schematically shows an item of seating furniture 1 in the form of an armchair, in a vertical section. The sectional plane is arranged, in this case, in the viewing direction, behind a front, and therefore not shown, side part of the seating furniture 1. The side part is identical to the side part 2 shown on the opposing side of the seating furniture 1. Provided between the two outer side parts 2 are a seat 3, a foot part 4 and a backrest 5. A mounting 6 is furthermore provided to adjust the seating furniture 1 between various positions. The mounting 6 is articulated to the foot part 4, the seat 3 and the backrest 5 and connected to a cross beam 7 below the seat 3.

In the shown and to this extent preferred seating furniture 1, the seat 3 is pivotably mounted by support plates 8 to the side parts 2. The rotational axis 9 to pivot the seat 3 is located in the front region of the seat 3. In the rear region of the seat 3, the latter rests firmly on corresponding stops 10, which are in each case laterally firmly connected to the seat parts 2. In the front part of the seat 3, the latter is pivotably connected to the foot part 4. In the rear part of the seat 3, the backrest 5 is also pivotably connected thereto.

The backrest 5 is pivotably connected to the foot part 4 by a coupling linkage 11. In addition, the backrest 5 is also pivotably connected by an actuating drive 12 to the cross beam 7 of the seating furniture 1. A coupling link 13 is in each case provided articulated to the seat 3 and the coupling linkage 11. A stop 14 is also supported relative to the cross beam 7.

In the reclining position shown in FIG. 1, the stop 14 does not have a function and the foot part 4 is located in a front use position, in which the user can place his feet and/or legs on the foot part 4. For better illustration, the upholstery of the foot part 4 and of the seat 3 and the backrest 5 is not shown. The support face 15 of the foot part 4 points upwardly in the front user position. Furthermore, the backrest 5 is inclined relatively far to the rear relative to the seat 3 in the reclining position. In the reclining position, the backrest 5 and seat 3 therefore enclose a relatively large opening angle a_{L}, which is significantly smaller than 180°.

From the reclining position shown in FIG. 1, the item of seating furniture 1 can be adjusted into the sitting position shown in FIG. 2. For this purpose, the actuating member 16 of the actuating drive 12 mounted on the backrest 5 in the shown and to this extent preferred seating furniture 1 is brought into a partly extended position. This leads to the fact that the backrest 5 is pivoted out of the reclining position into the sitting position in the direction of the seat 3. In the sitting position, the opening angle a_{S} between the backrest 5 and the seat 3 is consequently smaller than in the reclining position. In addition, the backrest 5 in the sitting position is placed more steeply and substantially vertically oriented in the shown and to this extent preferred seating furniture.

The position of the seat 3 changes, in the shown and to this extent preferred seating furniture 1, between the reclining position and the sitting position. However, it would be conceivable for the seat to be displaced forward when adjusted into the reclining position from the sitting position. Because of the coupling of the backrest 5 to the foot part 4, the pivoting of the backrest 5 into a more upright position leads to a pivoting of the foot part 4 from the front use position into a rear rest position. In this rear rest position, the foot part 4 rests on the stop 14, which is supported by the cross beam 7. The stop 14 ensures that the foot part 4 cannot be pivoted further to the rear below the seat 3. Because of the coupling between the foot part 4 and the backrest 5, the latter can also not be pivoted further into a more upright position.

If the actuating element 16 of the actuating drive 12 is further extended from the position shown in FIG. 2, the abutting of the foot part 4 on the stop 14 and the pivotable connection of the seat 3 to the base frame 17 leads to the seat 3, together with the backrest 5, being pivoted upward. In this case, the item of seating furniture 1 arrives in the standing up assistance position shown in FIG. 3.

In this position, the seat 3 is raised relative to a further stop 10 and the seat face of the seat 3 is inclined forward. The adjustment of the seating furniture 1 into the standing up assistance position has no influence on the position of the foot part 4 in relation to the base frame 17. The foot part 4 continues to rest on the stop 14. As the seat 3 has, however, been pivoted forward, the foot part 4 and the seat 3 enclose a larger angle β_{A} than in the sitting position. Despite the abutting of the foot part 4 on the stop 7, a pivoting movement of the foot part 4 relative to the seat 3 thus occurs, which is transmitted by the coupling linkage to the backrest 5. This transmission occurs in such a way that the backrest 5 is pivoted away from the seat 3, so a larger opening angle a_{A} is produced in the standing up assistance position between the backrest 5 and the seat 3 than in the sitting position. In the shown and to this extent preferred, seating furniture 1, a linear adjustment of the actuating drive, proceeding from the reclining position, firstly leads to a pivoting of the backrest 5 toward the seat 3, specifically reducing the opening angle a until the sitting position is reached.

In the standing up assistance position, the seat 3 is merely supported by the support plate 8 and the cross beam 7 relative to the two side parts 2. The further stop 10 does not then abut on the seat 3.

An adjustment of the seating furniture 1 from the standing up assistance position into the reclining position takes place in the same manner as the adjustment of the item of seating furniture 1 from the reclining position into the standing up assistance position. The individual steps of the adjustment of the seating furniture 1, however, proceed in the reverse order.

The backrest 5 and the foot part 4 are rigidly coupled by the coupling linkage 11 in the form of a continuous coupling rod, the backrest 5 and the foot part 4 being synchronously pivoted in each case as a result of the rigid coupling by the coupling linkage 11. This means that each pivoting operation of the foot part 4 or the backrest 5 results in a pivoting of the respective other component.

In an alternative item of seating furniture, not shown, the actuating element of the actuating drive could also engage directly on the seat and be configured merely to pivot the seat from the sitting position into the standing up assistance position. The adjustment of the seating furniture between the reclining position and the sitting position could then take place independently of the actuating drive. The coupling linkage would then preferably be connected by a spring means, such as, for example, a gas compression spring, to the cross beam, which exerts a restoring force on the coupling linkage, which has to be overcome both during pivoting from the reclining position into the sitting position and also during pivoting from the sitting position into the reclining position. Instead of a corresponding spring means, two or more spring means acting in opposite directions could also be provided.

A corresponding combination of the coupling linkage and spring means is already described in the German patent application 10 2009 019 100.3, which is to this extent made the subject of the present invention. In this case, it is advisable for the spring means to be fastened to the seat and when the seating furniture is adjusted from the sitting position into the standing up assistance position, the seat can be raised and/or pivoted therewith. With regard to the adjustment between the foot part and backrest, the spring means is always active, regardless of whether the seat is raised and/or pivoted into the standing up assistance position or not. The actuating drive is then merely necessary to move the seat out of the sitting position into the standing up assistance position. The relative adjustment of the foot part and backrest relative to the seat is achieved by the coupling linkage.

1. A seating furniture, comprising:
a base frame, a backrest, a seat and a foot part,
wherein the backrest and the foot part are coupled under the seat by a coupling linkage,
wherein the seat is held on the base frame so as to be pivotable from a sitting position into a standing up assistance position and
wherein the seat face of the seat is inclined forward in the standing up assistance position, and wherein
the coupling linkage is configured to transmit a pivoting movement of the backrest relative to the seat onto the foot part and vice versa,
a stop is provided to abut on the foot part, the coupling linkage and/or the backrest in a rear position of the foot part and
the stop is configured, together with the coupling linkage, to convert a pivoting of the seat relative to the base frame from the sitting position into a standing up assistance position into a pivoting of the backrest relative to the seat while increasing the opening angle between the backrest and seat.

2. The seating furniture according to claim 1, wherein the stop is configured to limit the degree of pivoting of the foot part from a front use position in the direction below the seat.

3. The seating furniture according to claim 1, wherein the stop is designed to keep the foot part in a substantially stationary position in relation to the base frame when the seat is pivoted from the sitting position into the standing up assistance position.

4. The seating furniture according to claim 1, wherein the backrest and the foot part are rigidly coupled by the coupling linkage.

5. The seating furniture according to claim 1, wherein the backrest and the foot part are coupled by means of the coupling linkage for constantly synchronous pivoting of the backrest and the foot part relative to the seat.

6. The seating furniture according to claim 1, wherein a further stop is provided, which limits the pivoting of the seat from the standing up assistance position into the sitting position.

7. The seating furniture according to claim 1, wherein an actuating drive is provided to pivot the seat from the sitting position into the standing up assistance position.

8. The seating furniture according to claim 7, wherein an actuating drive is provided to adjust the seating furniture from a reclining position with the foot part in a front use position via a sitting position with the foot part in a rear rest position through to the standing up assistance position with a seat face of the seat inclined forward.

9. The seating furniture according to claim 8, wherein the actuating element of the actuating drive with the foot part in the use position is in a retracted position, the actuating element with the seat in the standing up assistance position is in an extended position, and the actuating element in the sitting position is in a position between the retracted and the extended position.

10. The seating furniture according to claim 1, wherein the backrest is pivotably fastened to the seat.

11. The seating furniture according to claim 1, wherein the seat is pivotably fastened in the front region to the base frame.
